(19) United States
(12) Patent Application Publication
(10) Pub. No.: US 2025/0271404 A1
(43) Pub. Date: Aug. 28, 2025

(54) METHOD FOR QUANTIFYING MULTIPLY COMPOUNDS WITH SAME CHROMOPHORE USING SINGLE STANDARD

(71) Applicant: INSTITUTE OF CHINESE MATERIA MEDICA, CHINA ACADEMY OF CHINESE MEDICAL SCIENCES, Beijing (CN)

(72) Inventors: Yuntao DAI, Beijing (CN); Qian CHEN, Beijing (CN); Shilin CHEN, Beijing (CN); Pengyue LI, Beijing (CN); Runa JIN, Beijing (CN)

(73) Assignee: INSTITUTE OF CHINESE MATERIA MEDICA, CHINA ACADEMY OF CHINESE MEDICAL SCIENCES, Beijing (CN)

(21) Appl. No.: 19/026,531

(22) Filed: Jan. 17, 2025

Related U.S. Application Data
(63) Continuation of application No. PCT/CN2023/137774, filed on Dec. 11, 2023.

(30) Foreign Application Priority Data
Dec. 30, 2022 (CN) 202211726455.2

(51) Int. Cl. G01N 30/02; G01N 30/04; G01N 30/74; G01N 30/86

(52) U.S. Cl. CPC G01N 30/02; G01N 30/74; G01N 30/8606; G01N 2030/042

(57) ABSTRACT

A method for quantifying a plurality of compounds with the same chromophore using a single standard is provided. In the method, the standard curve of the standard is plotted, the calculation curve of the compound to be tested with the same chromophore as the standard is derived, and the quantitative determination of the compound to be tested is realized according to the calculation curve. The method requires few standards, leads to accurate determination results, and also saves time and costs in a series of methodological investigations such as establishment of individual standard curve for each component, thereby improving the efficiency of method development.

### CROSS REFERENCE TO THE RELATED APPLICATIONS

This application is a continuation application of International Application No. PCT/CN2023/137774, filed on Dec. 11, 2023, which is based upon and claims priority to Chinese Patent Application No. 202211726455.2, filed on Dec. 30, 2022, the entire contents of which are incorporated herein by reference.

### TECHNICAL FIELD

The present disclosure relates to the technical field of compound determination methods, and in particular to a method for quantifying a plurality of compounds with the same chromophore using a single standard.

### BACKGROUND

Complex systems are research objects that often occur in the chemical analysis and research. Complex systems are widely present in various fields such as food and medicine. Complex samples often include many structural analogues (including isomers, homologues, etc.) with similar physical and chemical properties. When a complex sample is subjected to compositional analysis, especially quantitative evaluation, it is necessary to quantitatively analyze a plurality of components to comprehensively characterize the quality of the complex sample.

There are the following two methods for the quantification of multi-components: traditional multi-standard quantification (the multi-standard curve method) and single-standard quantification of multiple components. In practical applications, the multi-standard curve method presents challenges such as a large workload and difficulty in obtaining standards, which are related to the fact that some standards are difficult to prepare or/and have unstable structures and high prices. Therefore, the use of a single standard to quantify a plurality of components has gradually become a research hotspot. Currently, the common single-standard quantification method is the quantitative analysis of multi-components by single marker. The quantitative analysis of multi-components by single marker was first proposed in 2006, in which a plurality of components are simultaneously quantified with a single standard by establishing an intrinsic functional relationship among different components. The quantitative analysis of multi-components by single marker is also known as single standard to determine multi-components (SSDMC). Currently, the SSDMC method based on liquid chromatography analysis is a major multi-component analysis method.

However, it has been found that the SSDMC method is still faced with many problems in applications. For example: 1) Error increase progressively: The quantitative analysis of a plurality of components by the SSDMC method involves many calculation steps, and an error is generated in each calculation step. Therefore, the overall error will be amplified step by step. 2) A relative correction factor (RCF) is required for the calculation of each component in a sample, but the RCF is influenced by many factors, and the calculated value has a large deviation, which makes it difficult to avoid errors. 3) Selection of internal reference substances: When an internal standard is a trace component in a sample, RCFs acquired by different laboratories are quite different; that is, a value of RCF fluctuates greatly, resulting in errors in the determination of the contents of a plurality of components. Therefore, how to simplify the multi-component quantification for a complex system, improve the efficiency of method development, and improve the accuracy of a method is a problem to be solved.

### SUMMARY

An objective of the present disclosure is to provide a method for quantifying a plurality of compounds with the same chromophore using a single standard. The method requires few standards, provides accurate determination results, and also saves time and costs in a series of methodological investigations such as establishment of individual standard curve for each component, thereby improving the efficiency of method development.

To achieve the objective of the present disclosure, the present disclosure provides the following technical solutions:

The present disclosure provides a method for quantifying a plurality of compounds with the same chromophore using a single standard, including the following steps:
1) detecting standard working solutions with different concentrations by high-performance liquid chromatography, and with mass concentrations as x-coordinate and peak areas as y-coordinate, plotting a standard curve of the mass concentrations and the peak areas for a standard;
2) according to a relationship between the mass concentrations and molar concentrations of the standard, plotting a standard curve of the molar concentrations and the peak areas for the standard; and
3) under a condition that a compound to be tested shares the same chromophore as the standard, and that a molar concentration C_{measured} of the compound to be tested is the same as a molar concentration Cᵣ of the standard, an absorbance y_{measured} of the compound to be tested is the same as an absorbance yᵣ of the standard, and basing on a relationship between mass concentrations and molar concentrations for the compound to be tested, plot a standard curve of the mass concentrations and peak areas for the compound to be tested:

$${y}_{measured} = \frac{{M}_{r}}{{M}_{m e a s u r e d}} {ax}_{m e a s u r e d} ( mg / mL ) + b , \qquad ( 5 )$$

where y_{measured} represents a peak area of the compound to be tested, x_{measured} represents a mass concentration of the compound to be tested, Mᵣ represents a molar mass of the standard, M_{measured} represents a molar mass of the compound to be tested, and a and b are parameters; and

substituting the peak area y_{measured} of the compound to be tested into the equation (5) to calculate the mass concentration x_{measured} of the compound to be tested.

The present disclosure provides a method for quantifying a plurality of compounds with the same chromophore using a single standard. The method of the present disclosure requires few standards. Standards are mostly expensive. Thus, compared with the multi-component quantification method adopting a plurality of standards, the method of the present disclosure reduces the cost, saves time and costs in a series of methodological investigations such as establishment of individual standard curve for each component, and improves the efficiency of method development. With the method of the present disclosure, only a standard curve for a component with a known standard is required to deduce standard curves for the remaining components to be quantified. In the existing SSDMC method, RCFs need to be determined for the remaining components to be quantified relative to the component with the known standard, and the RCFs are greatly affected by component concentrations, experimental conditions, etc., resulting in large errors of content determination results. In addition, the method of the present disclosure does not require the determination of a relationship among different components, and also does not require the cumbersome correction factors to correct other components, which avoids the influence of external factors such as instruments and laboratories and internal factors such as purities of standard substances, reduces the measurement time and components, and improves the efficiency and accuracy of quantification method development. The standard curve conversion for quantification in the present disclosure completely depends on a molar mass among physical characteristics of a compound. Once a compound to be tested is determined, a molar mass of the component remains unchanged. Therefore, the method of the present disclosure reduces the unnecessary errors, allows the free selection of internal reference substances, and does not need to consider a content of a compound in a sample.

### BRIEF DESCRIPTION OF THE DRAWINGS

FIG. 1 shows a high-performance liquid chromatography spectrum of a ginseng decoction piece as a test sample (in FIG. 1, 1 represents ginsenoside Rg1; 2 represents ginsenoside Re; 3 represents ginsenoside Rf; 4 represents ginsenoside Rb1; 5 represents ginsenoside Rb2; and 6 represents ginsenoside Rd);

FIG. 2 shows chemical structures of the ginsenosides;

FIG. 3 shows a high-performance liquid chromatography spectrum of a Scutellariae Radix decoction piece as a test sample (in FIG. 3, 1 represents baicalin; 2 represents wogonoside; and 3 represents baicalein);

FIG. 4 shows chemical structures of the baicalin, the wogonoside, and the baicalein; and

FIG. 5 is a comparison chart of determination results of Example 2 and Comparative Example 3.

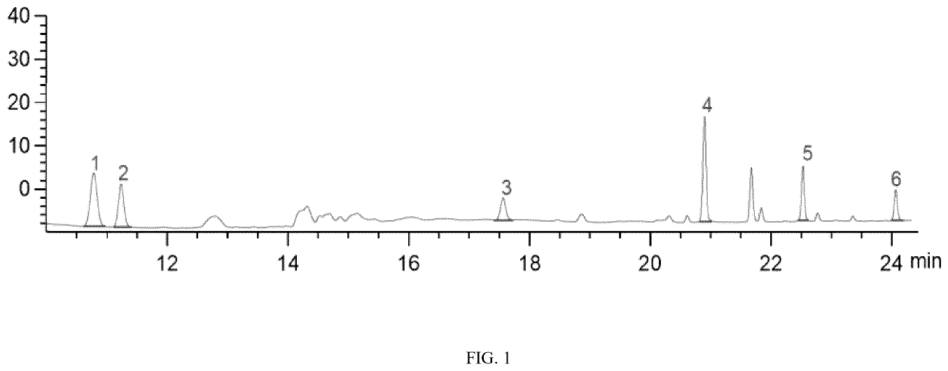

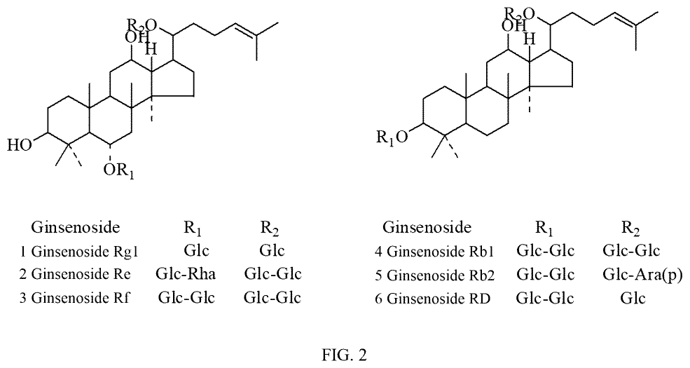

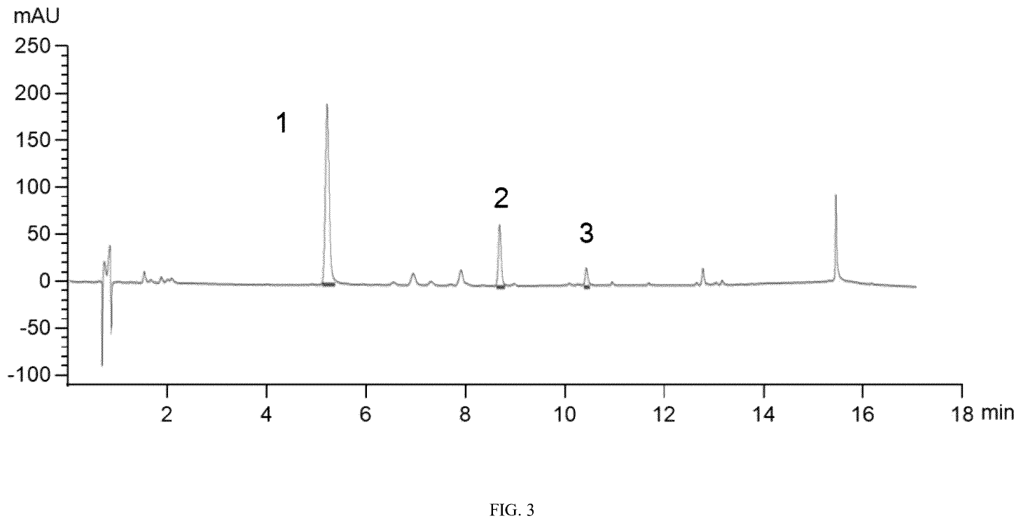

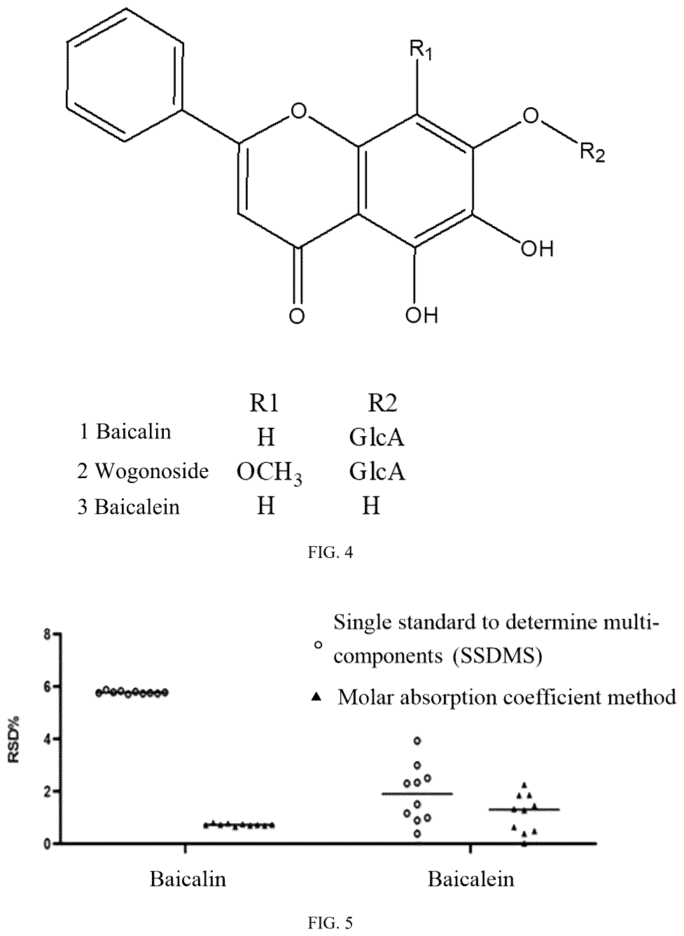

### DETAILED DESCRIPTION OF THE EMBODIMENTS

The present disclosure provides a method for quantifying a plurality of compounds with the same chromophore using a single standard, including the following steps:
1) Standard working solutions with different concentrations is detected by high-performance liquid chromatography, and with mass concentrations as x-coordinate and peak areas as y-coordinate, a standard curve of the mass concentrations and the peak areas for a standard is plotted.
2) According to a relationship between the mass concentrations and molar concentrations of the standard, a standard curve of the molar concentrations and the peak areas for the standard is plotted.
3) Under a condition that a compound to be tested shares the same chromophore as the standard, and that a molar concentration C_{measured} of the compound to be tested is the same as a molar concentration Cᵣ of the standard, an absorbance y measured of the compound to be tested is the same as an absorbance yᵣ of the standard, and based on a relationship between mass concentrations and molar concentrations for the compound to be tested, a standard curve of the mass concentrations and peak areas for the compound to be tested is plotted:

$${y}_{measured} = \frac{{M}_{r}}{{M}_{m e a s u r e d}} {ax}_{m e a s u r e d} ( mg / mL ) + b , \qquad ( 5 )$$

where y_{measured} represents a peak area of the compound to be tested, x_{measured} represents a mass concentration of the compound to be tested, Mᵣ represents a molar mass of the standard, M_{measured} represents a molar mass of the compound to be tested, and a and b are parameters.

A peak area y_{measured} of the compound to be tested is substituted into the equation (5) to calculate the mass concentration x_{measured} of the compound to be tested.

In the present disclosure, in the step 1), standard working solutions with different concentrations is detected by high-performance liquid chromatography, and with mass concentrations as x-coordinate and peak areas as y-coordinate, a standard curve of the mass concentrations and the peak areas for a standard is plotted. Preferably, the standard curve of the mass concentrations and the peak areas for the standard is as follows:

$${y}_{r} = {ax}_{r} ( mg / mL ) + b , \qquad ( 1 )$$

where yᵣ represents a peak area of the standard, xᵣ represents a mass concentration of the standard, and a and b are parameters.

In the present disclosure, in the step 2), according to a relationship between the mass concentrations and molar concentrations of the standard, a standard curve of the molar concentrations and the peak areas for the standard is plotted. Preferably, the relationship between the mass concentrations and the molar concentrations of the standard in the step 2) is as follows:

$${x}_{r} ( mg / mL ) = 1000 * {M}_{r} * {C}_{r} ( m mol / L ) , \qquad ( 2 )$$

where x, represents a mass concentration of the standard, Mᵣ represents the molar mass of the standard, and Cᵣ represents a molar concentration of the standard.

Preferably, the standard curve of the molar concentrations and the peak areas for the standard in the step 2) is as follows:

$${y}_{r} = a * 1000 * {M}_{r} * {C}_{r} ( mmol / L ) + b , \qquad ( 3 )$$

where y, represents a peak area of the standard, C, represents a molar concentration of the standard, Mᵣ represents the molar mass of the standard, and a and b are parameters.

In the present disclosure, in the step 3), under a condition that a compound to be tested shares the same chromophore as the standard, and that a molar concentration (measured of the compound to be tested is the same as a molar concentration C, of the standard, an absorbance y measured of the compound to be tested is the same as an absorbance y, of the standard, and based on a relationship between mass concentrations and molar concentrations for the compound to be tested, a standard curve of the mass concentrations and peak areas for the compound to be tested is plotted:

$${y}_{measured} = \frac{{M}_{r}}{{M}_{m e a s u r e d}} {ax}_{m e a s u r e d} ( mg / mL ) + b , \qquad ( 5 )$$

where y_{measured} represents a peak area of the compound to be tested, x_{measured} represents a mass concentration of the compound to be tested, Mᵣ represents a molar mass of the standard, M_{measured} represents a molar mass of the compound to be tested, and a and b are parameters.

A peak area y measured of the compound to be tested is substituted into the equation (5) to calculate the mass concentration x measured of the compound to be tested. Preferably, the relationship between the mass concentrations and the molar concentrations for the compound to be tested in the step 3) is as follows:

$${C}_{m e a s u r e d} = \frac{1}{1 \; 000 * {M}_{m e a s u r e d}} {x}_{m e a s u r e d} * ( mg / mL ) , \qquad ( 4 )$$

where C_{measured} represents a molar concentration of the compound to be tested, X measured represents a mass concentration of the compound to be tested, and M_{measured} represents a molar mass of the compound to be tested.

According to the Lambert-Beer law, a molar absorption coefficient ε refers to an absorbance of a 1 mol/L solution with a layer thickness of 1 cm, and compounds with a same concentration and a same chromophore should theoretically have a same absorbance. In high-performance liquid chromatography, a concentration is proportional to a peak area. For a plurality of compounds with a same chromophore, a molar concentration standard curve of a compound can be used to quantify other compounds.

A standard curve with a mass concentration as x and a peak area as y is established with a standard. According to the conversion of a mass concentration into a molar concentration, the standard curve is converted into a standard curve with a molar concentration as C and a peak area as y. Based on the principle that compounds with a same chromophore have a same absorbance when at a same molar concentration, a slope of the standard curve is converted to obtain mass concentration standard curves for other compounds, and then the converted standard curves are used to implement the quantification of other compounds. In this way, the compounds with the same chromophore are quantified by the single-standard curve method.

A specific equation deduction process is as follows:

Assuming that a sample includes i (i=1, 2, 3, . . . , m, . . . , k) components and structures of these components all include a same chromophore, a compound r is selected as an internal reference substance to establish a standard curve of mass concentrations and contents:

$${y}_{r} = {ax}_{r} ( mg / mL ) + b .$$

According to an equation for converting a mass concentration into a molar concentration:

$${C}_{r} ( mmol / L ) = \frac{n ( mmol )}{v ( L )} = \frac{m ( mg )}{{M}_{r} * v ( L )} = \frac{1}{1000 * {M}_{r}} {x}_{r} ( mg / mL )$$

the following equation is obtained:

$${x}_{r} ( mg / mL ) = 1000 * {M}_{r} * {C}_{r} ( mmol / L ) .$$

A standard curve of molar concentrations and peak areas for the internal reference substance is established:

$${y}_{r} = a * 1000 * {M}_{r} * {C}_{r} ( mmol / L ) + b .$$

Compounds with a same chromophore have a same absorbance value at a same molar concentration, that is:

When

$${C}_{r} ( mmol / L ) = {C}_{m e a s u r e d} ( mmol / L ) = \frac{1}{1000 * {M}_{m e a s u r e d}} {x}_{m e a s u r e d} ( mg / mL ) , {y}_{m e a s u r e d} = {y}_{r} = a * 1000 * {M}_{r} * {C}_{r} ( mmol / L ) + b .$$

A standard curve of mass concentrations and peak areas for a compound to be tested is established:

$${y}_{m e a s u r e d} = \frac{{M}_{r}}{{M}_{m e a s u r e d}} a {x}_{m e a s u r e d} ( mg / mL ) + b ,$$

where Mᵣ and M_{measured} represent molar masses of the internal reference substance r and the compound to be tested, respectively. Based on this equation, contents of other components can be calculated successively.

The technical solutions provided by the present disclosure are described in detail below with reference to examples, but the examples cannot be understood as limiting the protection scope of the present disclosure.

### Example 1

TABLE 1
Sources of raw materials adopted for Example 1 and experiments

| No. | Batch No. | Producing area | Collection time |
|---|---|---|---|
| RS1 | 180707 | Fusong, Jilin | 2018.7 |
| RS2 | 180708 | Fusong, Jilin | |
| RS3 | 180709 | Fusong, Jilin | |
| RS4 | 180710 | Fusong, Jilin | |
| RS5 | 180906 | Dunhua, Jilin | 2018.9 |
| RS6 | 180910 | Dunhua, Jilin | |
| RS7 | 20190601 | Changbai Mountain, | 2019.6 |
| | | Jilin | |
| RS8 | 20190602 | Changbai Mountain, | |
| | | Jilin | |
| RS9 | 20190603 | Changbai Mountain, | |
| | | Jilin | |
| RS10 | 20190605 | Changbai Mountain, | |
| | | Jilin | |

Preparation of standard solutions: A ginsenoside Rg1 was weighed accurately and dissolved in methanol to prepare a 1 mg/mL stock solution, and the stock solution was stored at 4° C. for later use. The stock solution was diluted with methanol 125-fold, 100-fold, 20-fold, 10-fold, 5-fold, 2.5-fold, and 2-fold to produce Rg1 solutions with concentrations of 0.008 mg/mL, 0.01 mg/mL, 0.05 mg/mL, 0.1 mg/mL, 0.2 mg/mL, 0.4 mg/mL, and 0.5 mg/mL, respectively.

Preparation of a test sample solution: A ginseng decoction piece was crushed and then sieved through a 50-mesh sieve to obtain a medicinal powder. 0.5 g of the medicinal powder was weighed out, 15 mL of methanol was added, and ultrasonic extraction was conducted for 30 min to obtain an extraction system. The extraction system was filtered to obtain a filter residue and a filtrate, 15 mL of methanol was added to the filter residue again for ultrasonic extraction for 30 min, and then filtered again, and the filter paper was rinsed with 10 mL of methanol for 3 times. Two filtrates were combined and subjected to rotary evaporation at 50° C. until a dry extract was obtained. The dry extract was dissolved in 10 mL of methanol to obtain an extract solution. The extract solution was centrifuged at 10,000 rpm for 10 min and then filtered through a 0.22 microporous filter membrane to obtain the test sample solution.

Chromatographic conditions: A chromatographic column was BEH C18 (100 mm×2.1 mm, 1.7 μm). Gradient elution was conducted with acetonitrile (A)-water (B) as a mobile phase: 0 min to 8 min: 19% of A; 8 min to 13 min: 19% to 29% of A; 13 min to 16 min: 29% of A; 16 min to 23 min: 29% to 40% of A; and 23 min to 26 min: 40% to 19% of A. A flow rate was 0.3 mL min⁻¹. A column temperature was 30° C. A detection wavelength was 203 nm. An injection volume was 2 μL. A sample chamber temperature was 10° C.

2 μL of both the test sample solution and each of the single-standard (Rg1) serial solutions were accurately pipetted and injected into a high-performance liquid chromatograph for chromatographic analysis. With the detection and calculation methods established by the present disclosure, contents of six ginsenosides in the ginseng decoction piece were calculated.

Results: A standard linear equation for Rg1 was y=1359.5 x+1.9403. Calculation linear equation for the remaining components, established according to the following equation, were shown in Table 2. Quantitative results obtained using the molar absorption coefficient method were shown in Table 3.

$${y}_{m e a s u r e d} = \frac{{M}_{r}}{{M}_{m e a s u r e d}} \times 1359.5 {x}_{m e a s u r e d} ( mg / mL ) + 1.9403 ,$$

Mᵣ represents a molar mass of the ginsenoside Rg1 and M_{measured} represents a molar mass of any of the other five ginsenosides (Re, Rf, Rb1, Rb2, and Rd).

A peak area y, as measured by an instrument, was substituted into the equation y=1359.5 x+1.9403 to calculate the mass concentration x of Rg1 (mg/mL). Then, according to the preparation method of the test sample solution, the mass concentration was multiplied by a volume of 10 mL for the final test sample solution and divided by the mass of 0.5 g for the medicinal powder to obtain a percentage content of Rg1 in the medicinal powder, namely, the data in Table 3. Concentrations and percentage contents of the remaining five ginsenosides were calculated using their respective calculation linear equations, as shown in Table 3.

TABLE 2
Calculation linear equations for the five ginsenosides in Example 1

| Component | Calculation linear equation |
|---|---|
| Re | y = 1149.7x + 1.9403 |
| Rf | y = 1359.5x + 1.9403 |
| Rb1 | y = 981.7x + 1.9403 |
| Rb2 | y = 1009x + 1.9403 |
| RD | y = 1130.6x + 1.9403 |

TABLE 3
Quantitative results of the determination method of the present disclosure in Example 1

| Ginseng decoction | | | | | | | | | | | |
|---|---|---|---|---|---|---|---|---|---|---|---|
| piece sample No. | | RS1 | RS2 | RS3 | RS4 | RS5 | RS6 | RS7 | RS8 | RS9 | RS10 |
| Rg1 | Content/% | 0.192 | 0.144 | 0.102 | 0.151 | 0.161 | 0.172 | 0.25 | 0.206 | 0.21 | 0.245 |
| Re | % | 0.147 | 0.096 | 0.087 | 0.121 | 0.113 | 0.154 | 0.129 | 0.196 | 0.179 | 0.183 |
| Rf | % | 0.057 | 0.049 | 0.036 | 0.053 | 0.051 | 0.054 | 0.073 | 0.072 | 0.072 | 0.085 |
| Rb1 | % | 0.254 | 0.167 | 0.155 | 0.188 | 0.188 | 0.223 | 0.229 | 0.242 | 0.241 | 0.304 |
| Rb2 | % | 0.117 | 0.08 | 0.062 | 0.101 | 0.083 | 0.122 | 0.086 | 0.113 | 0.097 | 0.131 |
| Rd | % | 0.061 | 0.038 | 0.037 | 0.055 | 0.039 | 0.046 | 0.03 | 0.031 | 0.036 | 0.038 |

### Comparative Example 1 (the Traditional Standard Curve Quantification Method, ES)

Preparation of standard solutions: Ginsenosides Rg1, Re, Rf, Rb1, Rb2, and Rd were accurately weighed and dissolved in methanol to prepare a 1 mg/mL stock solution, and the stock solution was stored at 4° C. for later use. The standard stock solutions of Rg1, Re, Rf, Rb1, Rb2, and Rd ginsenoside were mixed and then diluted 125-fold, 100-fold, 20-fold, 10-fold, 5-fold, 2.5-fold, and 2-fold.

Preparation of a test sample solution: A preparation method for the test sample solution was the same as that described in Example 1.

Chromatographic conditions: The chromatographic conditions were the same as those described in Example 1.

2 μL of both the test sample solution and each of the mixed standard (Rg1, Re, Rf, Rb1, Rb2, and Rd) serial solutions were accurately pipetted and injected into a high-performance liquid chromatograph for chromatographic analysis. Linear equations for standard curves of different components were established. Contents of six ginsenosides in the ginseng decoction piece were determined by a multi-standard curve method.

Results: A standard curve equation for each component was shown in Table 4. The comparison between results of the multi-standard curve determination in Comparative Example 1 and results of the single-standard curve determination in Example 1 was shown in Table 5. A peak area y, as measured by an instrument, was substituted into the standard curve equation in Table 4 to calculate the mass concentration x of each component (mg/mL). Then, according to the preparation method of the test sample solution, the mass concentration was multiplied by a volume of 10 mL for the final test sample solution and divided by the mass of 0.5 g for the medicinal powder to obtain a percentage content of each component in the medicinal powder. Percentage contents of other ginsenosides in the medicinal powder were calculated by the same method as for Rg1. Content data for Comparative Example 1 was shown in Table 5. Differences between the results of the single-standard curve determination in Example 1 and the results of the multi-standard curve determination in Comparative Example 1 were reflected by relative standard deviations (RSDs)/%.

TABLE 4
Standard curve equations for the six ginsenosides
determined in Comparative Example 1

| Component | Linear equation | R2 | Linear range (mg/mL) |
|---|---|---|---|
| Rg1 | y = 1359.5x + 1.9403 | 0.9998 | 0.0078872-0.49295 |
| Re | y = 1096.8x + 5.821 | 0.9991 | 0.0079264-0.4954 |
| Rf | y = 1402.7x + 1.1814 | 0.9993 | 0.0078824-0.49265 |
| Rb1 | y = 1009x − 0.4386 | 0.9997 | 0.0079104-0.4944 |
| Rb2 | y = 1025.3x + 1.7361 | 0.9992 | 0.00788-0.4925 |
| Rd | y = 1053.4x + 3.9688 | 0.9998 | 0.0078832-0.4927 |

TABLE 5
Comparison between results of the multi-standard curve determination in Comparative
Example 1 and results of the single-standard curve determination in Example 1

| Sample No. | | RS1 | RS2 | RS3 | RS4 | RS5 | RS6 | RS7 | RS8 | RS9 | RS10 |
|---|---|---|---|---|---|---|---|---|---|---|---|
| Rg1 | Content/% | 0.192 | 0.144 | 0.102 | 0.151 | 0.161 | 0.172 | 0.25 | 0.206 | 0.21 | 0.245 |
| Re | Example 1/% | 0.147 | 0.096 | 0.087 | 0.121 | 0.113 | 0.154 | 0.129 | 0.196 | 0.179 | 0.183 |
| | Comparative | 0.147 | 0.092 | 0.084 | 0.119 | 0.111 | 0.153 | 0.127 | 0.197 | 0.179 | 0.184 |
| | Example 1/% | | | | | | | | | | |
| | RSD/% | 0.078 | 2.667 | 2.398 | 1.478 | 1.393 | 0.103 | 1.263 | 0.184 | 0.301 | 0.307 |
| Rf | Example 1/% | 0.057 | 0.049 | 0.036 | 0.053 | 0.051 | 0.054 | 0.073 | 0.072 | 0.072 | 0.085 |
| | Comparative | 0.056 | 0.048 | 0.036 | 0.053 | 0.05 | 0.053 | 0.072 | 0.071 | 0.07 | 0.083 |
| | Example 1/% | | | | | | | | | | |
| | RSD/% | 0.86 | 0.628 | 0.083 | 0.76 | 0.695 | 0.787 | 1.151 | 1.131 | 1.122 | 1.302 |
| Rb1 | Example 1/% | 0.254 | 0.167 | 0.155 | 0.188 | 0.188 | 0.223 | 0.229 | 0.242 | 0.241 | 0.304 |
| | Comparative | 0.251 | 0.167 | 0.155 | 0.187 | 0.188 | 0.222 | 0.227 | 0.24 | 0.239 | 0.301 |
| | Example 1/% | | | | | | | | | | |
| | RSD/% | 0.627 | 0.043 | 0.201 | 0.172 | 0.176 | 0.451 | 0.485 | 0.563 | 0.557 | 0.843 |
| Rb2 | Example 1/% | 0.117 | 0.08 | 0.062 | 0.101 | 0.083 | 0.122 | 0.086 | 0.113 | 0.097 | 0.131 |
| | Comparative | 0.115 | 0.08 | 0.061 | 0.1 | 0.082 | 0.12 | 0.085 | 0.111 | 0.096 | 0.129 |
| | Example 1/% | | | | | | | | | | |
| | RSD/% | 0.893 | 0.785 | 0.679 | 0.856 | 0.797 | 0.903 | 0.807 | 0.885 | 0.844 | 0.919 |
| RD | Example 1/% | 0.061 | 0.038 | 0.037 | 0.055 | 0.039 | 0.046 | 0.03 | 0.031 | 0.036 | 0.038 |
| | Comparative | 0.061 | 0.037 | 0.036 | 0.055 | 0.038 | 0.046 | 0.029 | 0.029 | 0.035 | 0.037 |
| | Example 1/% | | | | | | | | | | |
| | RSD/% | 0.778 | 1.842 | 0.036 | 0.288 | 1.737 | 0.632 | 3.752 | 3.525 | 2.186 | 1.958 |

It can be seen from the above results that, compared with the traditional multi-standard curve determination method in Comparative Example 1, the determination method in Example 1 of the present disclosure can simultaneously detect the contents of six chemical components (ginsenosides Rg1, Re, Rf, Rb1, Rb2, and Rd) with the same chromophore in ginseng, and can lead to similar results to the traditional multi-standard curve determination method in Comparative Example 1, indicating that the novel method of the present disclosure can be used for the accurate determination of the six components in ginseng.

### Example 2

TABLE 6
Sources of raw materials adopted for Example 2 and experiments

| No. | Batch No. | Producing area | Collection time |
|---|---|---|---|
| S1 | 180705 | Lingchuan, Shanxi | 2018.7 |
| S2 | 180706 | Lingchuan, Shanxi | |
| S3 | 180707 | Lingchuan, Shanxi | |
| S4 | 180908 | Changzhi, Shanxi | |
| S5 | 180909 | Changzhi, Shanxi | 2018.9 |
| S6 | 180910 | Changzhi, Shanxi | |
| S7 | 20190601 | Chengde, Hebei | 2019.6 |
| S8 | 20190602 | Chengde, Hebei | |
| S9 | 20190604 | Chengde, Hebei | |
| S10 | 20190605 | Chengde, Hebei | |

Preparation of standard solutions: Wogonoside was weighed accurately and dissolved in dimethyl sulfoxide (DMSO) to prepare a 1 mg/mL stock solution, and the stock solution was stored at 4° C. for later use. The stock solution was diluted with DMSO 1,000-fold, 200-fold, 100-fold, 50-fold, 25-fold, 20-fold, 12.5-fold, 10-fold, 5-fold, 3.33-fold, and 2.5-fold to produce wogonoside solutions with concentrations of 1 μg/mL, 5 μg/mL, 10 μg/mL, 20 μg/mL, 40 μg/mL, 50 μg/mL, 80 μg/mL, 100 μg/mL, 200 μg/mL, 300 μg/mL, and 400 μg/mL, respectively.

Preparation of a test sample solution: A Scutellariae Radix decoction piece was crushed and then sieved through a 60-mesh sieve to obtain a medicinal powder. 0.1 g of the medicinal powder was weighed out, 50 mL of 70% methanol was added, and ultrasonic extraction was conducted for 15 min (room temperature, 40 kHz) to obtain an extraction system. The extraction system was centrifuged at 10,000 rpm for 10 min to obtain a supernatant, and then the supernatant was filtered through a 0.22 microporous filter membrane to obtain the test sample solution.

Chromatographic conditions: A chromatographic column was HSS T3 (100 mm×2.1 mm, 1.8 μm). Gradient elution was conducted with 0.2% phosphoric acid aqueous solution (A)-acetonitrile (B) as a mobile phase: 0 min to 2 min: 78% to 75% of A; 2 min to 4 min: 75% of A; 4 min to 6 min: 75% to 68% of A; 6 min to 7 min: 68% to 60% of A; 7 min to 8 min: 60% of A; 8 min to 10 min: 60% to 50% of A; 10 min to 13 min: 50% to 5% of A; and 13 min to 17 min: 5% to 78% of A. A flow rate was 0.35 mL min⁻¹. A column temperature was 30° C. A detection wavelength was 280 nm. An injection volume was 1 μL. A sample chamber temperature was 10° C.

1 μL of both the test sample solution and each of the single-standard (wogonoside) serial solutions were accurately pipetted and injected into a high-performance liquid chromatograph for chromatographic analysis. Contents of three flavonoids in the Scutellariae Radix decoction piece were calculated by the single-standard curve method established by the present disclosure.

Results: A standard linear equation for wogonoside was y=5.5879 x−5.2928. Standard curves for the remaining components that were established according to the following equation were shown in Table 7. Quantitative results of contents were shown in Table 8:

$${y}_{m e a s u r e d} = \frac{5.5879 \times {M}_{r}}{{M}_{m e a s u r e d}} {x}_{m e a s u r e d} ( mg / mL ) - 5.2 \; 928 , \qquad ( 6 )$$

Mᵣ represents a molar mass of wogonoside and M_{measured} represents a molar mass of each of the other two flavonoids (baicalin and baicalein).

A content of wogonoside was calculated by a peak area of wogonoside: A peak area y, as measured by an instrument, was substituted into the equation y=5.5879 x−5.2928 to calculate the mass concentration x of wogonoside (mg/mL). Then, according to the preparation method of the test sample solution, the mass concentration was multiplied by a volume of 50 mL for the final test sample solution and divided by the mass of 0.1 g for the medicinal powder to obtain a percentage content of wogonoside in the medicinal powder.

Contents of baicalin and baicalein were calculated: According to the equation (6), the standard linear equation y=5.5879 x−5.2928 for wogonoside was first converted into calculation linear equation for the remaining components (as shown in Table 7). Peak areas y, as measured by an instrument for baicalin and baicalein, were substituted into respective curves in Table 7 to calculate mass concentrations x of baicalin and baicalein (mg/mL), respectively. Then, according to the preparation method of the test sample solution, the mass concentrations each were multiplied by a volume of 50 mL for the final test sample solution and divided by the mass of 0.1 g for the medicinal powder to obtain percentage contents of baicalin and baicalein in the medicinal powder.

TABLE 7
Linear equations for the three flavonoids determined in Example 2

| Component | Calculation linear equation |
|---|---|
| Wogonoside | y = 5.5879x − 5.2928 |
| Baicalin | y = 5.7637x − 5.2928 |
| Baicalein | y = 9.5199x − 5.2928 |

TABLE 8
Quantitative results of the determination method of the present disclosure in Example 2

| Sample No. | | S1 | S2 | S3 | S4 | S5 | S6 | S7 | S8 | S9 | S10 |
|---|---|---|---|---|---|---|---|---|---|---|---|
| Wogonoside | Content/% | 3.274 | 3.044 | 3.282 | 2.825 | 3.036 | 3.561 | 3.111 | 2.917 | 3.110 | 3.149 |
| Baicalin | Quantitative | 13.314 | 12.678 | 13.609 | 12.902 | 14.975 | 15.970 | 13.531 | 11.966 | 13.212 | 13.970 |
| | content/% | | | | | | | | | | |
| Baicalein | Quantitative | 0.558 | 0.448 | 0.554 | 0.723 | 0.415 | 0.300 | 0.265 | 0.311 | 0.225 | 0.424 |
| | content/% | | | | | | | | | | |

### Comparative Example 2 (the Traditional Multi-Standard Curve Quantification Method)

Preparation of standard solutions: Wogonoside, baicalin, and baicalein each were accurately weighed. Wogonoside was dissolved in DMSO and baicalin and baicalein each were dissolved in methanol to prepare 1 mg/mL stock solutions, and the stock solutions were stored at 4° C. for later use. The stock solutions of wogonoside, baicalin, and baicalein were diluted separately. The wogonoside stock solution was diluted 1,000-fold, 200-fold, 100-fold, 50-fold, 25-fold, 20-fold, 12.5-fold, 10-fold, 5-fold, 3.33-fold, and 2.5-fold. The baicalin stock solution was diluted 200-fold, 100-fold, 12.5-fold, 5-fold, 3.33-fold, and 2.5-fold. The baicalein stock solution was diluted 1,000-fold, 500-fold, 250-fold, 100-fold, 66.67-fold, and 50-fold.

Preparation of a test sample solution: A preparation method for the test sample solution was the same as that described in Example 2.

Chromatographic conditions: The chromatographic conditions were the same as those described in Example 2.

1 μL of both the test sample solution and each of the standard (wogonoside, baicalin, and baicalein) serial solutions were accurately pipetted and injected into a high-performance liquid chromatograph for chromatographic analysis. Contents of three flavonoids in the Scutellariae Radix decoction piece were calculated by the multi-standard curve method.

Results: A standard curve equation for each component was shown in Table 9. The comparison between results of the multi-standard curve determination in Comparative Example 2 and results of the detection method in Example 2 of the present disclosure was shown in Table 10.

TABLE 9
Standard curve equations for the three flavonoids
determined in Comparative Example 2

| Component | Linear equation | R2 | Linear range (μg/mL) |
|---|---|---|---|
| Rg1 | y = 5.5879x − 5.2928 | 0.9999 | 0.985-394 |
| Re | y = 5.8682x − 17.19 | 0.9991 | 4.77-381.6 |
| Rf | y = 9.0546x − 2.7957 | 0.9990 | 0.985-19.7 |

TABLE 10
Comparison between results of the multi-standard curve determination in Comparative
Example 2 and results of the detection method in Example 2 of the present disclosure

| Sample No. | | S1 | S2 | S3 | S4 | S5 | S6 | S7 | S8 | S9 | S10 |
|---|---|---|---|---|---|---|---|---|---|---|---|
| Wogonoside | Content/% | 3.274 | 3.044 | 3.282 | 2.825 | 3.036 | 3.561 | 3.111 | 2.917 | 3.110 | 3.149 |
| Baicalin | Example 2/% | 13.314 | 12.678 | 13.609 | 12.902 | 14.975 | 15.970 | 13.531 | 11.966 | 13.212 | 13.970 |
| | Comparative | 13.177 | 12.553 | 13.467 | 12.772 | 14.809 | 15.786 | 13.391 | 11.854 | 13.077 | 13.821 |
| | Example 2/% | | | | | | | | | | |
| | RSD/% | 0.728 | 0.702 | 0.740 | 0.713 | 0.789 | 0.816 | 0.736 | 0.664 | 0.726 | 0.754 |
| Baicalein | Example 2/% | 0.558 | 0.448 | 0.554 | 0.723 | 0.415 | 0.300 | 0.265 | 0.311 | 0.225 | 0.424 |
| | Comparative | 0.573 | 0.458 | 0.569 | 0.747 | 0.422 | 0.302 | 0.265 | 0.313 | 0.223 | 0.432 |
| | Example 2/% | | | | | | | | | | |
| | RSD/% | 1.873 | 1.464 | 1.863 | 2.262 | 1.288 | 0.394 | 0.024 | 0.499 | 0.651 | 1.337 |

It can be seen from Comparative Example 2 that, compared with the conventional multi-standard curve method, the detection method provided in Example 2 of the present disclosure can simultaneously detect the contents of three chemical components (wogonoside, baicalin, and baicalein) with the same chromophore in Scutellariae Radix, and results all have RSDs/% of less than 3%, indicating that the method of the present disclosure can lead to accurate results when used in the determination of three flavonoids with a same chromophore in Scutellariae Radix.

### Comparative Example 3 (the Existing SSDMC)

Preparation of standard solutions: The preparation for the standard solutions was the same as that described in Comparative Example 2.

Preparation of a test sample solution: The preparation was the same as that described in Example 2.

Chromatographic conditions: The chromatographic conditions were the same as those described in Example 2.

1 μL of both the test sample solution and each of the standard (wogonoside, baicalin, and baicalein) serial solutions were accurately pipetted and injected into a high-performance liquid chromatograph for chromatographic analysis. Contents of three flavonoids in the Scutellariae Radix decoction piece were calculated by the multi-standard curve method.

Determination of RCFs: With wogonoside as a single reference standard, the RCFs for baicalin and baicalein each were calculated according to the following equation:

$$R C F = \frac{{k}_{r}}{{k}_{m e a s u r e d}} ,$$

where k, represents a slope of a standard curve for wogonoside and k_{measured} represents a slope of a standard curve for each of baicalin and baicalein. Results were shown in Table 13.

A peak area measured by an instrument, RCF in Table 11, and a mass concentration x (mg/mL) calculated for wogonoside were substituted into the following equation:

$${x}_{m e a s u r e d} = \frac{R C F \times {A}_{m e α s u r e d}}{\frac{{A}_{r}}{{x}_{r}}}$$

where A, and x, represent a peak area and a mass concentration of wogonoside, respectively, A_{measured} and x_{measured} represent a peak area and a mass concentration of baicalin or baicalein, respectively, and RCF represents RCF of baicalin or baicalein (Table 11).

Then, according to the preparation method of the test sample solution, the mass concentrations x measured of baicalin and baicalein obtained by the above steps each were multiplied by a volume of 50 mL for the final test sample solution and divided by the mass of 0.1 g for the medicinal powder to obtain percentage contents of baicalin and baicalein in the medicinal powder, namely, the data in Table 12.

TABLE 11
RCFs of baicalin and baicalein

| Component | Baicalin | Baicalein |
|---|---|---|
| RCF | 1.03 | 0.62 |

TABLE 12
Comparison between determination results of the multi-standard curve method in Comparative
Example 2 and determination results of the SSDMC method in Comparative Example 3

| Sample No. | | RS1 | RS2 | RS3 | RS4 | RS5 | RS6 | RS7 | RS8 | RS9 | RS10 |
|---|---|---|---|---|---|---|---|---|---|---|---|
| Wogonoside | Content/% | 3.274 | 3.044 | 3.282 | 2.825 | 3.036 | 3.561 | 3.111 | 2.917 | 3.110 | 3.149 |
| Baicalin | SSDMC | 14.288 | 13.618 | 14.605 | 13.876 | 16.094 | 17.129 | 14.533 | 12.860 | 14.189 | 15.003 |
| | method/% | | | | | | | | | | |
| | Multi- | 13.177 | 12.553 | 13.467 | 12.772 | 14.809 | 15.786 | 13.391 | 11.854 | 13.077 | 13.821 |
| | standard | | | | | | | | | | |
| | curve | | | | | | | | | | |
| | method/% | | | | | | | | | | |
| | RSD/% | 5.718 | 5.742 | 5.741 | 5.836 | 5.885 | 5.809 | 5.788 | 5.764 | 5.765 | 5.782 |
| Baicalein | SSDMC | 0.566 | 0.449 | 0.562 | 0.744 | 0.413 | 0.290 | 0.254 | 0.302 | 0.211 | 0.423 |
| | method/% | | | | | | | | | | |
| | Multi- | 0.573 | 0.458 | 0.569 | 0.747 | 0.422 | 0.302 | 0.265 | 0.313 | 0.223 | 0.432 |
| | standard | | | | | | | | | | |
| | curve | | | | | | | | | | |
| | method/% | | | | | | | | | | |
| | RSD/% | 0.894 | 1.167 | 0.995 | 0.390 | 1.511 | 2.345 | 3.004 | 2.510 | 3.936 | 2.308 |

It can be seen from Comparative Example 3 that, in contrast to the determination results of the conventional multi-standard curve method, determination results of baicalin by the existing SSDMC method have much larger RSD/% than those by the detection method in Example 2 of the present disclosure (as shown in Table 10, Table 12, and FIG. 5). The method for simultaneously detecting three chemical components (wogonoside, baicalin, and baicalein) with identical chromophore in Scutellariae Radix provided by the present disclosure has quantitative results that are very similar to those of the multi-standard curve method, indicating that the method provides accurate quantitative results with small errors.

It can be seen from the above examples that the detection method of Example 2 provided in the present disclosure is used to simultaneously detect the contents of three chemical components (wogonoside, baicalin, and baicalein) with the same chromophore in Scutellariae Radix. The comparison of the results with the multi-standard curve method (Table 10) proves that the detection method described in the present disclosure is accurate in determining the three components in Scutellariae Radix. Compared with the existing SSDMC method, the detection method in the present disclosure yield results that are closer to the quantitative results by the multi-standard curve method, indicating that the quantitative results by the established method in the present disclosure are more accurate. As shown in Tables 10 and 12, it further illustrates that the method established in the present disclosure has higher accuracy than the existing method, and does not require the determination of RCFs or multiple standard curves, saving workload and improving efficiency.

TABLE 13
Peak area values for components in Examples 1 and 2

| | Peak area | | | | | | | | | |
|---|---|---|---|---|---|---|---|---|---|---|
| Sample No. | Wogonoside | Baicalin | Baicalein | Sample No. | Rg1 | Re | Rf | Rb1 | Rb2 | RD |
| S1 | 362.8 | 1538.6 | 101.7 | RS1 | 135.1 | 88.3 | 41.3 | 128.9 | 61.9 | 36.9 |
| S2 | 338.0 | 1469.3 | 80.9 | RS2 | 100.6 | 57.4 | 35.4 | 85.6 | 43.3 | 23.9 |
| S3 | 364.4 | 1576.0 | 101.0 | RS3 | 72.9 | 52.6 | 26.8 | 79.3 | 33.6 | 23.3 |
| S4 | 313.6 | 1496.8 | 133.8 | RS4 | 105.5 | 72.3 | 38.5 | 95.9 | 53.9 | 33.4 |
| S5 | 336.8 | 1734.7 | 74.3 | RS5 | 112.9 | 67.9 | 36.9 | 96.1 | 44.7 | 24.3 |
| S6 | 393.9 | 1841.1 | 52.0 | RS6 | 120.7 | 91.6 | 39.2 | 113.8 | 64.5 | 28.4 |
| S7 | 344.2 | 1562.3 | 45.5 | RS7 | 172.9 | 76.7 | 52.1 | 116.4 | 46.2 | 19.4 |
| S8 | 321.4 | 1376.9 | 54.0 | RS8 | 143.5 | 115.9 | 51.2 | 123.0 | 60.0 | 19.8 |
| S9 | 345.8 | 1533.0 | 38.1 | RS9 | 145.6 | 105.7 | 50.9 | 122.5 | 51.8 | 22.9 |
| S10 | 349.1 | 1616.3 | 76.0 | RS10 | 170.5 | 108.6 | 60.5 | 154.2 | 69.3 | 23.6 |

The above are merely preferred embodiments of the present disclosure. It should be noted that a person of ordinary skill in the art may further make several improvements and modifications without departing from the principles of the present disclosure, but such improvements and modifications should be deemed as falling within the protection scope of the present disclosure.

What is claimed is:

1. A method for quantifying a plurality of compounds with a same chromophore using a single standard, comprising the following steps:
1) detecting standard working solutions with different concentrations by high-performance liquid chromatography, and with mass concentrations as x-coordinate and peak areas as y-coordinate, plotting a standard curve of the mass concentrations and the peak areas for a standard;
2) according to a relationship between the mass concentrations and molar concentrations of the standard, plotting a standard curve of the molar concentrations and the peak areas for the standard; and
3) under a condition that a compound to be tested shares the same chromophore as the standard, and that a molar concentration C_{measured} of the compound to be tested is equal to a molar concentration Cᵣ of the standard, an absorbance y measured of the compound to be tested is equal to an absorbance yᵣ of the standard, and basing on a relationship between mass concentrations and molar concentrations for the compound to be tested, plot a standard curve of the mass concentrations and peak areas for the compound to be tested:
$${y}_{m e a s u r e d} = \frac{{M}_{r}}{{M}_{m e a s u r e d}} {ax}_{m e a s u r e d} ( mg / mL ) + b , \qquad ( 5 )$$
wherein y_{measured} represents a peak area of the compound to be tested, x_{measured} represents a mass concentration of the compound to be tested, Mᵣ represents a molar mass of the standard, M_{measured} represents a molar concentration of the compound to be tested, and a and b are parameters; and
substituting the peak area y_{measured} of the compound to be tested into the equation (5) to calculate the mass concentration x_{measured} of the compound to be tested.

2. The method for quantifying the plurality of compounds with the same chromophore using the single standard according to claim 1, wherein the standard curve of the mass concentrations and the peak areas for the standard in the step 1) is as follows:
$${y}_{r} = {ax}_{r} ( mg / mL ) + b , \qquad ( 1 )$$
wherein yᵣ represents a peak area of the standard, xᵣ represents a mass concentration of the standard, and the a and the b are the parameters.

3. The method for quantifying the plurality of compounds with the same chromophore using the single standard according to claim 1, wherein the relationship between the mass concentrations and the molar concentrations of the standard in the step 2) is as follows:
$${x}_{r} ( mg / mL ) = 1000 * {M}_{r} * {C}_{r} ( mmol / L ) , \qquad ( 2 )$$
wherein x, represents a mass concentration of the standard, Mᵣ represents the molar mass of the standard, and Cᵣ represents a molar concentration of the standard.

4. The method for quantifying the plurality of compounds with the same chromophore using the single standard according to claim 1, wherein the standard curve of the molar concentrations and the peak areas for the standard in the step 2) is as follows:
$${y}_{r} = a * 1000 * {M}_{r} * {C}_{r} ( mmol / L ) + b , \qquad ( 3 )$$
wherein y, represents a peak area of the standard, C, represents a molar concentration of the standard, Mᵣ represents the molar mass of the standard, and the a and the b are the parameters.

5. The method for quantifying the plurality of compounds with the same chromophore using the single standard according to claim 1, wherein the relationship between the mass concentrations and the molar concentrations for the compound to be tested in the step 3) is as follows:
$${C}_{m e a s u r e d} = \frac{1}{1 \; 000 * {M}_{m e a s u r e d}} {x}_{m e a s u r e d} ( mg / mL ) , \qquad ( 4 )$$
wherein C_{measured} represents a molar concentration of the compound to be tested, Xmeasured represents the mass concentration of the compound to be tested, and M_{measured} represents a molar mass of the compound to be tested.
